(19) United States
(12) Patent Application Publication
(10) Pub. No.: US 2007/0127072 A1
(43) Pub. Date: Jun. 7, 2007

(54) LAYOUT METHOD, APPARATUS AND COMPUTER PROGRAM

(76) Inventor: Tetsuya Katsuragi, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/562,509

(22) Filed: Nov. 22, 2006

(30) Foreign Application Priority Data
Dec. 6, 2005 (JP) 2005-352327

(51) Int. Cl. G06K 15/00

(52) U.S. Cl. 358/1.18; 358/1.2

(57) ABSTRACT

Processing for laying out a plurality of hierarchical objects includes decision processing for deciding the height of a selected object. In the decision processing, the height of a lower-level object that belongs to the selected object is decided by executing the decision processing recursively. In the decision processing, the height of the selected object is decided based upon the height of the lower-level object that belongs to the selected object.

### BACKGROUND OF THE INVENTION

1. Field of the Invention

The present invention relates to a method, apparatus and computer program for laying out a plurality of hierarchical objects.

2. Description of the Related Art

In general, an application such as a web browser that displays HTML text and the like first analyzes all elements present within an HTML or other document to be rendered and generates a rectangular-object tree representing the hierarchical structure of rectangular objects that are to be laid out. Next, the application decides the position and size of each rectangular object based upon constraining conditions obtained by analyzing the rectangular-object tree.

In a case where a rectangular-object tree is generated from HTML text or the like, the position and size of a certain rectangular object must be decided upon taking into account constraining conditions imposed by rectangular objects that are of higher or lower order relative to this rectangular object. This makes necessary processing for organizing these constraining conditions and deciding the optimum positions and sizes of all rectangular objects automatically.

However, processing for organizing constraining conditions and adjusting the positions and sizes of all rectangular objects necessitates a high computation cost and it is difficult to achieve operation with embedded devices, etc., having a comparatively low computation capability and subject to severe limitations in terms of computation resources.

### SUMMARY OF THE INVENTION

The present invention lays out a plurality of hierarchical objects at a low computation cost.

Further, the present invention provides a method of laying out a plurality of hierarchical objects comprising a decision step of deciding the height of a selected object; the decision step deciding the height of a lower-level object that belongs to the selected object by executing the decision step recursively; wherein at the decision step, the height of the selected object is decided based upon the height of the lower-level object that belongs to the selected object.

Further, the present invention provides an apparatus for laying out a plurality of hierarchical objects, comprising a decision unit that decides the height of a selected object; the decision unit deciding the height of a lower-level object that belongs to the selected object by recursively executing decision processing for deciding the height of the selected object; wherein the decision unit decides the height of the selected object based upon the height of the lower-level object that belongs to the selected object.

Further features of the present invention will become apparent from the following description of exemplary embodiments with reference to the attached drawings.

### BRIEF DESCRIPTION OF THE DRAWINGS

FIG. 1 is a block diagram schematically illustrating the hardware configuration of an information processing apparatus according to an embodiment of the present invention;

FIG. 2 is a flowchart illustrating an overview of operation of processing for rendering HTML text;

FIG. 3 is a diagram illustrating an example of an HTML document to be processed;

FIG. 4 is a diagram illustrating a tree of rectangular objects and an image of results of layout; and

FIG. 5 is a flowchart illustrating a processing operation regarding every rectangular object for deciding a layout.

### DESCRIPTION OF THE EMBODIMENTS

An embodiment of the present invention will now be described in detail with reference to the accompanying drawings. It should be noted that the constituents described in this embodiment are exemplary and that the scope of the present invention is not limited solely to these constituents.

(Hardware Configuration)

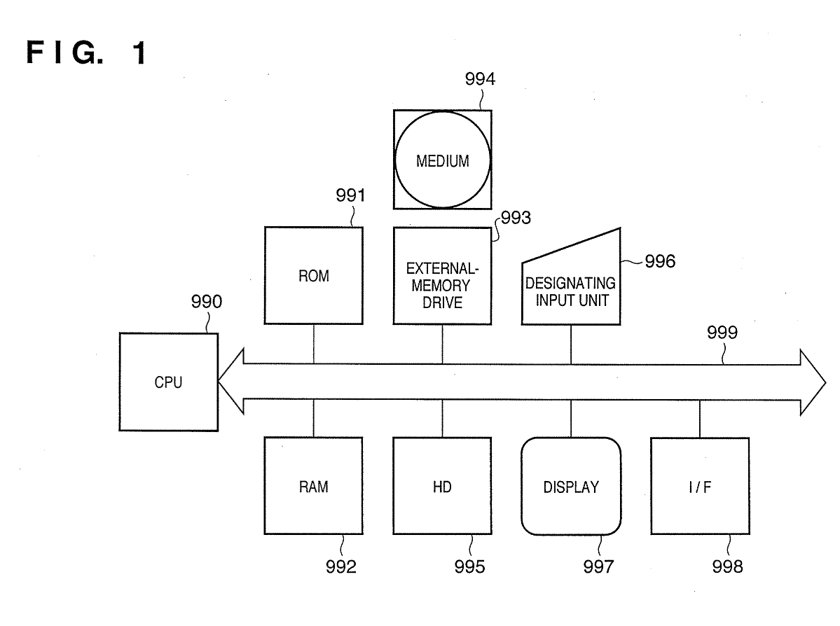

The hardware configuration of an information processing apparatus according to this embodiment will be described with reference to FIG. 1. FIG. 1 is a block diagram schematically illustrating the hardware configuration of an information processing apparatus according to an embodiment of the present invention. It should be noted that the information processing apparatus according to this embodiment is implemented by, e.g., a personal computer, a workstation, a Personal Digital Assistant (PDA), a mobile telephone or a digital camera, etc.

In FIG. 1, a CPU 990 executes an application program, an operating system and a control program, etc., that have been stored in a hard-disk drive 995, described later, and exercises control for temporarily storing information and files, etc., which are necessary for program execution, in a RAM 992.

A ROM 991 stores internally a program such as a basic input/output program, and various data such as font data and template data used in this basic processing. The RAM 992 stores various data temporarily and functions as a main memory and work area, etc., of the CPU 990.

An external-memory drive 993, which is for implementing access to a recording medium, is capable of loading programs, etc., which have been stored on a medium (recording medium) 994, in this computer system. It should be noted that examples of the medium 994 include a flexible disk, CD-ROM, CD-R, CD-RW, PC card, DVD, IC memory card, magneto-optical disk and memory stick, etc.

An external storage device 995 in this embodiment employs a hard disk (HD) that functions as a large-capacity memory. An application program, operating system, control program and related programs, etc., are stored on the hard disk 995.

A designating input unit 996 corresponds to a keyboard, pointing device (a mouse, etc.) or touch-sensitive panel, etc. Using the designating input unit 996, the user inputs and specifies commands, etc., which are for controlling the apparatus, to the information processing apparatus according to this embodiment.

A display 997 displays commands entered from the designating input unit 996 and outputs of the information processing apparatus in response to these commands.

A system bus 999 controls the flow of data within the information processing apparatus, and an interface (I/F) 998 performs an exchange of data with external devices.

It should be noted that the apparatus may be implemented by replacing the hardware components with software for implementing functions equivalent to those of the components described above.

This embodiment illustrates an example in which processing is executed upon directly loading the program and related data according to this embodiment from the medium 994 to the RAM 992. However, the invention is not limited to this arrangement. For example, it may be so arranged that whenever the program according to this embodiment is operated, the program is loaded in the RAM 992 from the hard disk 995 in which the program has already been installed. Further, it is possible to record the program of the embodiment in the ROM 991 in advance, arrange this so as to form part of a bitmap and execute the program directly by the CPU 990.

Further, this embodiment is such that the information processing apparatus according to the embodiment is implemented by a single apparatus for the sake of explanation. However, it may be implemented by an arrangement in which resources are dispersed among a plurality of devices. For example, an arrangement in which memory and computation resources are dispersed among a plurality of devices may be adopted. Alternatively, resources may be dispersed among individual constituents implemented virtually in the information processing apparatus, and parallel processing may be executed.

(Overall Processing)

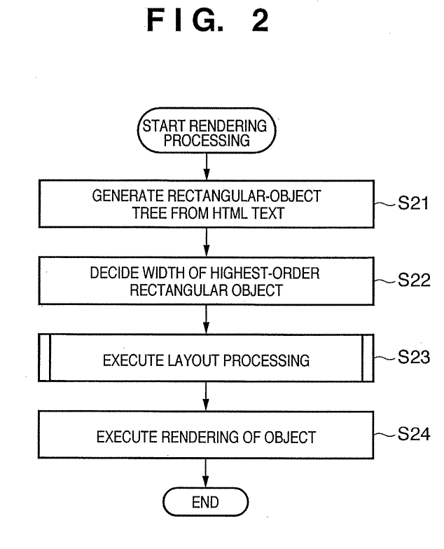

The overall processing executed by the arrangement according to this embodiment will be described with reference to FIG. 2. FIG. 2 is a flowchart illustrating an overview of operation of processing for rendering HTML text according to this embodiment.

First, at step S21, HTML text that has entered from the interface 998 or medium 994 is analyzed and an object tree in which rectangular objects are adopted as nodes is generated. Here the following processing is executed:

(1) Elements relating to rendering are converted to an assemblage of rectangular objects, which has a tree-like hierarchical structure, based upon the entered HTML text.

(2) Next, a placement rule, minimum width value and optimum width (reference width) value are stored with regard to each rectangular object based upon attribute values, etc., of the elements.

(3) Results of calculation are set for each rectangular object. The results of calculation are stored in a storage device such as the RAM 992 in correspondence with each node.

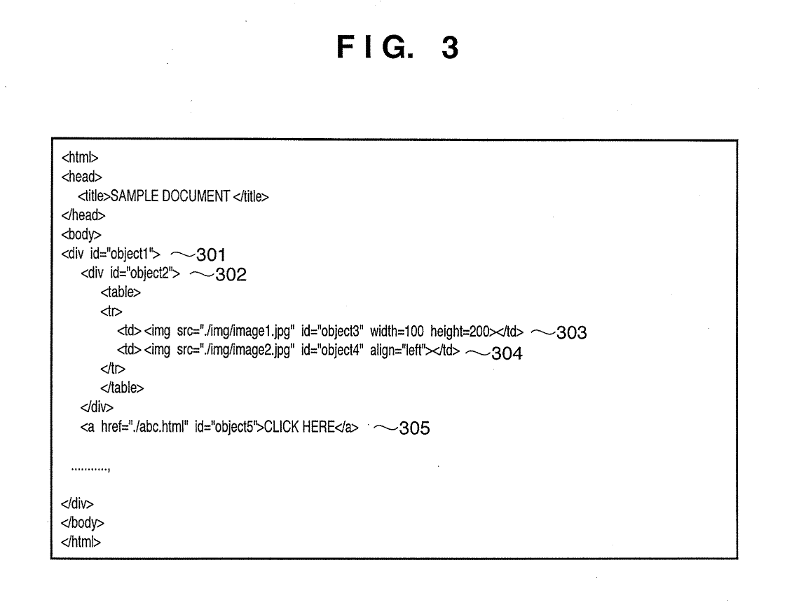

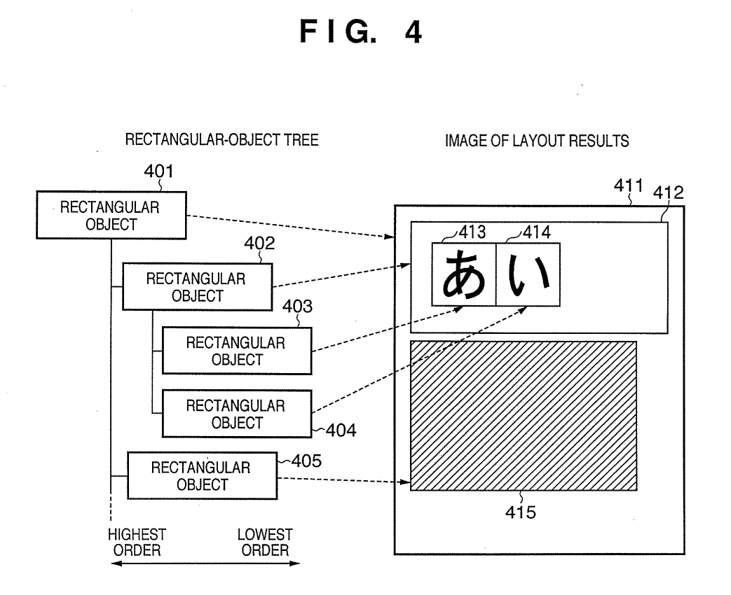

Reference will be had to FIGS. 3 and 4 to describe an overview of processing for making the conversion to the assemblage of rectangular objects set forth in (1) above. FIG. 3 is a diagram illustrating an example of an HTML document to be processed. FIG. 4 illustrates a tree of rectangular objects generated in the course of processing by an HTML-text rendering unit to which this embodiment is applied, as well as an image of results of layout obtained after processing. The dashed-line arrows in FIG. 4 represent the correspondence between each of the rectangular objects and layout result.

The information processing apparatus according to this embodiment generates a tree of the kind shown in FIG. 4 based upon an inclusion relationship of tags that constitute an HTML document. For example, in FIG. 3, it is so arranged that a tag 301 includes other tags 302 to 305. A rectangular object relating to tag 301 corresponds to a rectangular object 401 of highest order in FIG. 4. Tags 302 and 305 exist in a hierarchical level (child nodes) that is one level below the tag 301. The rectangular object relating to tag 302, therefore, corresponds to a rectangular object 402, and the rectangular object relating to tag 305 corresponds to a rectangular object 405. Similarly, a rectangular object relating to a tag 303 corresponds to a rectangular object 403, and a rectangular object relating to a tag 304 corresponds to a rectangular object 404. It should be noted that the rectangular objects 401, 402, 403, 404 and 405 correspond to 411, 412, 413, 414 and 415, respectively, as indicated by the dashed-line arrows in FIG. 4.

With regard to each rectangular object mentioned in (2) above, processing for calculating a placement rule, minimum width value and optimum width value is executed based upon the attribute values of the elements and the content of the HTML tags, etc.

For example, in HTML, how a rectangular object is laid out can be described using an “align” attribute, as indicated by tag 304. Accordingly, the value of the “align” attribute, etc., is acquired as a placement rule. In a case where the value of the “align” attribute, etc., has not been described, as at tags 303 and 305, processing is executed assuming that the placement rule has been defined by a prescribed default value (e.g., center).

Further, with regard to minimum width value, in a case where a rectangular object is one in which a character string is laid out, as at tag 305, the width necessary to display a minimum of one character can be made the minimum width value. Alternatively, in a case where a rectangular object is one in which image data is laid out, as at tags 303 and 304, the minimum width value can be decided by the width of the original image data or by the value of a “width” attribute, etc. For example, a value obtained by multiplying the width of original image data or the value of a “width” attribute by a prescribed percentage (e.g., 10%) can be decided upon as the minimum width value.

Further, with regard to optimum width value, in a case where a rectangular object is one in which a character string is laid out, as at tag 305, the width necessary to display the character string up to its end or the width for displaying a prescribed number of characters (e.g., 30 characters) can be made the optimum width value. Alternatively, in a case where a rectangular object is one in which image data is laid out, as at tags 303 and 304, the optimum width value can be decided by the width of the original image data or by the value of a “width” attribute, etc.

It should be noted that the content of processing for calculating a placement rule, minimum width value and maximum width value is not necessarily limited to that described above. That is, any processing may be applied so long as these can be acquired at low calculation cost based upon the attribute values of elements or content of HTML tags.

In processing for setting results of calculation for each rectangular object mentioned in (3) above, a placement rule, minimum width value and optimum width value are stored in a storage device such as the RAM 992 on a per-object basis in addition to the parent-child relationship between the identifier of the object and other objects.

With reference again to FIG. 2, after the processing of step S21 is completed, the width of the highest-order rectangular object constituting the HTML document is decided at step S22. The width of the highest-order rectangular object is decided based upon such information as the resolution of the display unit (display) that displays the rendered HTML text, the medium on which printing is performed and the resolution of rendering, etc. The resolution of the display unit is set in the hard disk 995 beforehand. The print medium and the resolution of rendering are selected by the designating input unit 996.

Next, at step S23, layout decision processing for deciding the layout of each rectangular object constituting the HTML document is executed. The details of this processing will be described later.

Next, at step S24, rendering of the HTML document is finally performed based upon the position and height of each rectangular object decided at step S23. The position of a rectangular object is represented by the coordinates of any vertex of the rectangular object. Accordingly, an area that the rectangular object occupies on a screen is determined by the position, height and width of the rectangular object.

(Layout Decision Processing)

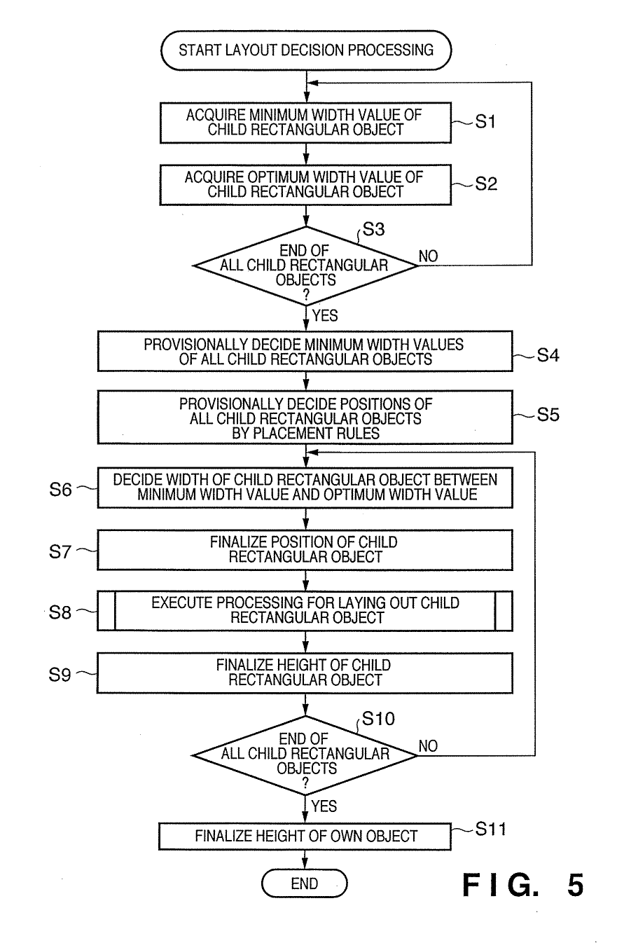

Next, reference will be had to FIG. 5 to describe layout decision processing executed at step S23. FIG. 5 is a flowchart illustrating a processing operation regarding every rectangular object for deciding a layout in an apparatus that converts HTML text to a tree structure of rectangular objects and renders the HTML text.

The processing of FIG. 5 is executed recursively in order, starting from the highest-order mode, with regard to all objects constituting the HTML document.

First, at steps S1 to S3, processing for forming a hierarchical level that is one level below one's own level (the node of interest, which initially is the highest-order node), i.e., processing for acquiring the minimum width values and optimum width values regarding all rectangular objects corresponding to child nodes, is executed. That is, at step S1, the hierarchical level that is one level below one's own level (the highest-order node), namely the minimum width value of a rectangular object corresponding to a child node, is acquired. Next, at step S2, the optimum width value of the rectangular object corresponding to this child node is acquired. The node at which the optimum width value is acquired is the same as the node at which the minimum width value was acquired at step S1. The acquisition of the minimum width value and optimum width value of the rectangular object at steps S1 and S2 is performed by referring to values stored in correspondence with the identifier of the rectangular object at step S21.

Next, at step S3, it is determined whether the processing of steps S1 and S2 has been completed with respect to all rectangular objects one level lower than oneself, i.e., all rectangular objects corresponding to child nodes. If processing regarding all objects has been completed (“YES” at step S3), control proceeds to step S4. If this processing has not been completed with regard to all objects (“NO” at step S3), then control returns to step S1 and the processing of steps S1 and S2 is executed with regard to nodes for which this processing has not been executed.

At step S4, minimum width values are set provisionally as the widths of the rectangular objects with regard to respective ones of all rectangular objects one level lower, i.e., rectangular objects corresponding to child nodes. That is, with regard to all rectangular objects one level lower, i.e., all rectangular objects corresponding to child nodes, the identifiers of the objects and the minimum width values are stored in correspondence with each other in a storage device such as the RAM 992.

Next, at step S5, the rectangular objects one level lower, i.e., rectangular objects corresponding to child nodes, are laid out provisionally by the placement rules possessed by the objects. That is, the positions of the rectangular objects one level lower, i.e., of the rectangular objects corresponding to child nodes, are decided provisionally based upon the values of “align” attributes, by way of example.

Next, at steps S6 to S10, processing for deciding the widths, positions and heights regarding respective ones of all of the rectangular objects one level lower than one's own level is executed.

First, at step S6, from among the rectangular objects one level lower, i.e., the rectangular objects corresponding to child nodes, one rectangular object that has not yet been processed is selected as a rectangular object to be processed, and the width of this rectangular object is finally decided. The width decision is performed based upon the provisional position obtained at step S5, the minimum width value acquired at step S1 and the optimum width value acquired at step S2. For example, the width of a rectangular object between the optimum width value and minimum width value is decided from conditions such as the width of the layout target, such as a sheet of paper or display screen, and the placement rules of other rectangular objects in the same hierarchical level (e.g., whether objects are to be laid out uniformly or laid out with left justification).

Next, at step S7, based upon the width, etc., of the rectangular object decided at step S6, the horizontal position of the rectangular object one level lower, i.e., the rectangular object corresponding to the child node, is finalized. That is, the horizontally directed area on the screen occupied by the rectangular object one level lower, i.e., the rectangular object corresponding to the child node, is finalized based upon the width of the object, the size of the screen and the placement rule, etc.

Next, at step S8, if the rectangular object to be processed selected at step S6 has a child node (a node one additional level lower), the layout decision processing illustrated in FIG. 5 is executed recursively with regard to the rectangular object to be processed selected at step S6. That is, the processing of steps S1 to S11 is executed with regard to the rectangular object to be processed selected at step S6. By thus applying layout decision processing to a rectangular object one level lower, i.e., a rectangular object corresponding to a child node, the layout of all rectangular objects below the rectangular object to be processed selected at step S6 is decided recursively. It should be noted that if the rectangular object to be processed selected at step S6 does not possess a child node (a node one additional level lower), control proceeds to step S9 without execution of step S8.

Next, at step S9, based upon the height of the rectangular object two or more levels lower obtained at step S8, the height of the rectangular object one level lower, i.e., of the rectangular object corresponding to the child node (the rectangular object to be processed selected at step S6) is decided. It should be noted that the height of the rectangular object can be decided based upon the width of the rectangular object, the placement rule and the attribute (“height”, etc.) of the HTML tag. Thus, in layout decision processing, the heights of rectangular objects are decided in order from lower to higher based upon the height of the object below. In a case where the highest-order node has rectangular objects two or more levels lower, the height of the rectangular object one level lower, namely of the rectangular object corresponding to the child node of the highest-order mode, is decided based upon the height of the rectangular object two or more levels lower obtained at step S8.

Next, at step S10, it is determined whether the processing of step S6 to S9 has been completed with regard to all rectangular objects one level lower, i.e., all rectangular objects corresponding to child nodes. If processing has been completed (“YES” at step S10), control proceeds to step S11. If processing has not been completed (“NO” at step S10), then control returns to step S6 and the processing of steps S6 to S9 is executed with regard to rectangular objects that have not yet been processed.

Next, at step S11, the height of one's own rectangular object is determined based upon the height of the rectangular object one level lower, namely of the rectangular object corresponding to the child node, obtained at step S9.

By executing the processing indicated by the operation flowchart of FIG. 5, the positions, widths and heights of all rectangular objects are finally decided.

Thus, in the arrangement according to this embodiment, first an HTML document is analyzed and a tree structure generated, and placement rules, minimum width values and optimum width values of rectangular objects corresponding to respective ones of nodes of the tree are calculated based upon tag analysis, etc. Based upon these three values and the width of the higher-order rectangular object, processing is executed recursively in the direction of the higher-order to lower-order rectangular objects in the rectangular-object tree. As a result, the three values of width, position and height necessary for laying out the rectangular objects are decided in order. That is, processing for deciding the width and position of the rectangular object to be processed is executed recursively on the basis of the width of the higher-order rectangular object and minimum-width information, basic-width information and placement-rule information of a rectangular object to be processed. It should be evident from the foregoing description that the content of the recursively executed computations is very simple.

Thus, in the arrangement according to this embodiment, it is unnecessary to take into account constraining conditions imposed by a lower- or higher-order rectangular object when the position, width and height of a certain rectangular object are decided. That is, it is unnecessary to organize constraining conditions and to adjust position and size regarding all rectangular objects. In accordance with the arrangement of this embodiment, therefore, HTML documents and the like can be rendered at low computation cost. Further, by applying the arrangement according to this embodiment, layout decision processing can be executed even in devices having a comparatively low computation capability.

Although HTML is assumed to be the document to be processed in the description given above, the invention is not limited to HTML. For example, the invention is applicable to a document described in XML or subsets thereof, wherein document layout, etc., is described by tags and attributes, etc.

Further, although it is assumed above that rectangular objects are displayed on a screen that can be scrolled vertically, an arrangement similar to that described above can be applied also in a case where the rectangular objects are displayed on a horizontally scrollable screen. That is, the above-described arrangement can be applied by reading “width in the vertical direction” instead of “width” and “height in the horizontal direction” instead of height, and reading “position in the vertical direction” instead of “position” determined at step S7.

### OTHER EMBODIMENTS

Although an embodiment of the present invention has been described above in detail, the present invention can be taken as an embodiment in the form of a system, apparatus, method, program or storage medium, etc. More specifically, the invention may be applied to a system comprising a plurality of devices and to an apparatus comprising a single device.

Furthermore, the present invention includes a case where the object of the invention is attained also by supplying a software program, which implements the functions of the foregoing embodiment, directly or remotely to a system or apparatus, reading the supplied program codes with a computer of the system or apparatus, and then executing the program codes.

Accordingly, since the functional processing of the present invention is implemented by computer, the program codes per se installed in the computer also fall within the technical scope of the present invention. In other words, the present invention also covers a computer program that is for the purpose of implementing the functional processing of the present invention.

In this case, so long as the system or apparatus has the functions of the program, the form of the program, e.g., object code, a program executed by an interpreter or script data supplied to an operating system, etc., does not matter.

Examples of recording media for supplying the program are a hard disk, optical disk, magneto-optical disk, CD-ROM, CD-R, CD-RW, magnetic tape, non-volatile type memory card, ROM, DVD (DVD-ROM, DVD-R), etc.

As for the method of supplying the program, a client computer can be connected to a website on the Internet using a browser possessed by the client computer, and the computer program of the present invention or an automatically installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer also is covered by the present invention.

Further, it is also possible to encrypt and store the program of the present invention on a storage medium such as a CD-ROM, distribute the storage medium to users, allow users who meet certain requirements to download decryption key information from a website via the Internet, and allow these users to run the encrypted program by using the key information, whereby the program is installed in the user computer. This form of supply also is possible.

Furthermore, besides the case where the aforesaid functions according to the embodiment are implemented by executing the read program by computer, an operating system or the like running on the computer may perform all or a part of the actual processing based upon the program instructions so that the functions of the foregoing embodiment can be implemented by this processing.

Furthermore, after the program read from the recording medium is written to a memory provided on a function expansion board inserted into the computer or in a function expansion unit connected to the computer, a CPU or the like mounted on the function expansion board or function expansion unit performs all or a part of the actual processing so that the functions of the foregoing embodiment can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-352327, filed Dec. 6, 2005, which is hereby incorporated by reference herein in its entirety.

What is claimed is:

1. A method of laying out a plurality of hierarchical objects, comprising:
a decision step of deciding the height of a selected object;
said decision step deciding the height of a lower-level object that belongs to the selected object by executing said decision step recursively; and
wherein at said decision step, the height of the selected object is decided based upon the height of the lower-level object that belongs to the selected object.

2. The method according to claim 1, said decision step including selecting an object, selecting a lower-level object that belongs to the selected object, deciding the height of the selected lower-level object, and deciding the height of the selected object based upon the height of the selected lower-level object;
wherein at the step of deciding the height of the selected lower-level object, the decision step of deciding the height of the selected object is executed recursively.

3. The method according to claim 1, said decision step including deciding the height of a second-level object that belongs to a selected first-level object based upon the height of a lower-level object that belongs to the second-level object;
wherein the height of the lower-level object that belongs to the second-level object is decided by executing said decision step with regard to the lower-level object that belongs to the second-level object.

4. The method according to claim 1, wherein at said decision step, the width and position of the lower-level object that belongs to the selected object are decided based upon the width and position of the selected object.

5. The method according to claim 1, wherein at said decision step, elements within a hierarchical document are handled as rectangular objects.

6. The method according to claim 1, wherein at said decision step, the height of the selected object is decided based upon width information that has been set for the selected object.

7. The method according to claim 1, wherein at said decision step, the height of the first-level object is decided based upon output width of an object that has been laid out.

8. An apparatus for laying out a plurality of hierarchical objects, comprising:
a decision unit that decides the height of a selected object;
said decision unit deciding the height of a lower-level object that belongs to the selected object by recursively executing decision processing for deciding the height of the selected object;
wherein said decision unit decides the height of the selected object based upon the height of the lower-level object that belongs to the selected object.

9. The apparatus according to claim 8, said decision unit selecting an object, selecting a lower-level object that belongs to the selected object, deciding the height of the selected lower-level object, and deciding the height of the selected object based upon the height of the selected lower-level object;
wherein in processing for deciding the height of the selected lower-level object, said decision unit recursively executes decision processing for deciding the height of the selected object.

10. The apparatus according to claim 8, wherein said decision unit decides the height of a second-level object that belongs to a selected first-level object based upon the height of a lower-level object that belongs to the second-level object;
wherein the height of the lower-level object that belongs to the second-level object is decided by executing the decision processing with regard to the lower-level object that belongs to the second-level object.

11. The apparatus according to claim 8, wherein said decision unit decides the width and position of the lower-level object that belongs to the selected object are decided based upon the width and position of the selected object.

12. The apparatus according to claim 8, wherein said decision unit handles elements within a hierarchical document as rectangular objects.

13. The apparatus according to claim 8, wherein said decision unit decides the height of the selected object based upon width information that has been set for the selected object.

14. The apparatus according to claim 8, wherein said decision unit decides the height of the first-level object based upon output width of an object that has been laid out.

15. A computer program that has been stored on a storage medium of a layout apparatus for laying out a plurality of hierarchical objects, comprising:
a decision step of deciding the height of a selected object;
said decision step deciding the height of a lower-level object that belongs to the selected object by executing said decision step recursively; and
wherein at said decision step, the height of the selected object is decided based upon the height of the lower-level object that belongs to the selected object.

16. The computer program according to claim 15, said decision step including selecting an object, selecting a lower-level object that belongs to the selected object, deciding the height of the selected lower-level object, and deciding the height of the selected object based upon the height of the selected lower-level object;
wherein at the step of deciding the height of the selected lower-level object, the decision step of deciding the height of the selected object is executed recursively.

17. The computer program according to claim 15, said decision step including deciding the height of a second-level object that belongs to a selected first-level object based upon the height of a lower-level object that belongs to the second-level object;
wherein the height of the lower-level object that belongs to the second-level object is decided by executing said decision step with regard to the lower-level object that belongs to the second-level object.

18. The computer program according to claim 15, wherein at said decision step, the width and position of the lower-level object that belongs to the selected object are decided based upon the width and position of the selected object.

19. The computer program according to claim 15, wherein at said decision step, the height of the selected object is decided based upon width information that has been set for the selected object.

20. The computer program according to claim 15, wherein at said decision step, the height of the first-level object is decided based upon output width of an object that has been laid out.
